(19) United States
(12) Patent Application Publication
(10) Pub. No.: US 2011/0089147 A1
(43) Pub. Date: Apr. 21, 2011

(54) BELT WELDING APPARATUS AND METHOD

(76) Inventor: Ronnie B. ACORS, Spotsylvania, VA (US)

(21) Appl. No.: 12/603,263

(22) Filed: Oct. 21, 2009

(51) Int. Cl. B23K 11/24

(52) U.S. Cl. 219/108; 219/117.1

(57) ABSTRACT

A handheld welder is provided for welding together parts of a workpiece. The welder may include a pair of three-part clamps with spring-loading so as to temporarily hold the parts of the workpiece in place before tightening the clamps. A housing can be provided for housing batteries or at least part of a power cord and for structurally supporting a heater element during welding. The housing can include radially-extending screws that are slidably provided within slots of a sleeve to allow the housing to axially move within the sleeve, so that the heater element may be at least partially retracted into the sleeve once the welding operation is completed.

### BACKGROUND

This invention relates to a method and apparatus for welding together parts of a workpiece, e.g., ends of a new or broken endless belt. The invention particularly relates to a method and apparatus for welding together a thermoplastic endless belt using a battery operated welder.

Thermoplastic endless belts have been commonly used in food service production lines or in escalator handrails. These inexpensive belts can bend freely and withstand a high load because they are made of a thermoplastic material. A belt welder can be used to bond the free ends of an endless belt together during a new installation or repair of the endless belt.

Conventional belt welders are usually large and powered by standard electrical outlets through long power cords. Although the conventional belt welders are effective at welding endless belts together, the long cord can be burdensome in a crowded and safety-conscious assembly line. Also, food production lines require a clean environment and electrical outlets can be difficult to sanitize. The conventional welders further suffer from structural and functional shortcomings independent of the power source.

To overcome the shortcomings of the conventional belt welders, the instant inventor devised a battery-powered handheld belt welder as disclosed and illustrated in WO 2007/044093, which is incorporated herein by reference in its entirety. The battery-powered welder did not require a long cord or electrical outlet and thus overcame shortcomings of the conventional belt welders. The belt welder of WO 2007/044093 included a pair of clamps that held the two ends of an endless belt in position. A heated nickel-chrome (ni-chrome) wire or ribbon “heating element” then contacted the two ends, thereby melting the two ends of the endless belt. The two melted ends of the belt could then be engaged with one another to facilitate bonding of the endless belt.

### SUMMARY

The belt welder of WO 2007/044093 can be improved upon in several ways. For example, the belt welder of WO 2007/044093 includes a clamping mechanism that holds the two ends of the endless belt in place. However, the clamping mechanism includes two-part clamps that maintain the positions of the belt parts only after a user rotates tension screws to engage the two clamps against the endless belt. The clamping mechanism does not provide any pressure against the endless belt parts while the user positions the endless belt parts relative to the heating element.

The belt welder of WO 2007/044093 allows the heating element to be moved away from the endless belt once the two ends of the endless belt are sufficiently melted. However, the heating element remains substantially exposed after it heats the endless belt. Therefore, a user could be burned if care is not taken to avoid the exposed heating element after it is used to melt the thermoplastic endless belt.

The belt welder of WO 2007/044093 allows the heating element to move relative to the endless belt by disposing the heating element on rods that extend from the base of the belt welder. The rods are inserted into openings provided in the base of the belt welder and are moved axially within the openings. However, this structure does not provide the best possible support and versatility for the heating element or the most compact design.

Accordingly, the instant inventor devised an improved handheld welder that includes a sleeve, a power source, a housing slidably connected to the sleeve, a heater element electrically connected to the power source, and a clamping mechanism for clamping a workpiece. The clamping mechanism can be coupled to the sleeve and include at least a first clamp having an upper body, a middle body and a lower body.

Also provided is a welder including a sleeve, a power source, a housing slidably connected to the sleeve, a heater element electrically connected to the power source, and a clamping mechanism for clamping a workpiece. The clamping mechanism can be coupled to the sleeve, and the sleeve can be structured to at least partially house the heater element within the sleeve when a portion of the housing is slidably withdrawn from the sleeve.

Further, a welder is provided that includes a sleeve, a power source, a housing, a clamping mechanism for clamping a workpiece, the clamping mechanism being coupled to the sleeve, and a heater element connected to the housing and electrically connected to the power source. The heater element can be movable relative to the clamping mechanism, and one of the housing and the sleeve can include a screw and another of the housing and the sleeve can include a slot structured to receive the screw to allow axial movement while preventing rotational movement of the housing relative to the sleeve.

A method of welding parts of a workpiece using a handheld welder is also provided, and includes inserting the workpiece parts between upper clamp bodies and middle clamp bodies of a clamping mechanism, turning adjustment screws between lower clamp bodies and the middle clamp bodies of the clamping mechanism to move the upper clamp bodies toward the middle clamp bodies and thereby provide compressive forces against the workpiece parts, moving a heater element between the parts of the workpiece, moving the parts of the workpiece against the heater element, activating the heater element until the parts of the workpiece are at least partially incited, removing the heater element from between the parts of the workpiece, and moving the parts of the workpiece into engagement with one another to weld the parts together.

A handheld welder is also provided, and includes a sleeve, a power source, a housing slidably connected to the sleeve, one of the housing and the sleeve including a screw and another of the housing and the sleeve including a slot structured to receive the screw to allow axial movement while preventing rotational movement of the housing relative to the sleeve, a heater element electrically connected to the power source, a clamping mechanism for clamping a workpiece, the clamping mechanism being coupled to the sleeve and having first and second clamps separated from one another, each of the first and second clamps having an upper body, a middle body and a lower body, the upper body including an extended portion that is configured to extend above the clamp base, the extended portion being thinner than a portion of the upper body above the middle body, a spring, between the middle body and the lower body, which biases the upper body toward the middle body when a workpiece is inserted between the upper body and the middle body, a clamp base between the first and second clamps, and a shaft, inserted into a threaded hole of the middle body of each of the first and second clamps, for simultaneously moving the first and second clamps toward and away from each other, where the sleeve is structured to substantially house the heater element within the sleeve when a portion of the housing is slidably withdrawn from the sleeve.

### BRIEF DESCRIPTION OF THE DRAWINGS

Reference will now be made, by way of example, to the accompanying drawings in which:

FIG. 1A is a perspective view of one embodiment of the welding apparatus;

FIG. 1B is an end view of the embodiment shown in FIG. 1A;

FIG. 1C is a perspective view of another embodiment of the welding apparatus;

FIG. 1D is an end view of the embodiment shown in FIG. 1C;

FIG. 2A is an enlarged perspective view of the clamping mechanism of the welding apparatus shown in FIG. 1A or 1C;

FIGS. 2B and 2C are side and front views, respectively, of the clamping mechanism shown in FIG. 2A;

FIG. 3A is a perspective view of a heater element of the welding apparatus shown in FIG. 1A; and

FIG. 3B is an exploded view of the heater element shown in FIG. 3A.

### DETAILED DESCRIPTION OF EMBODIMENTS

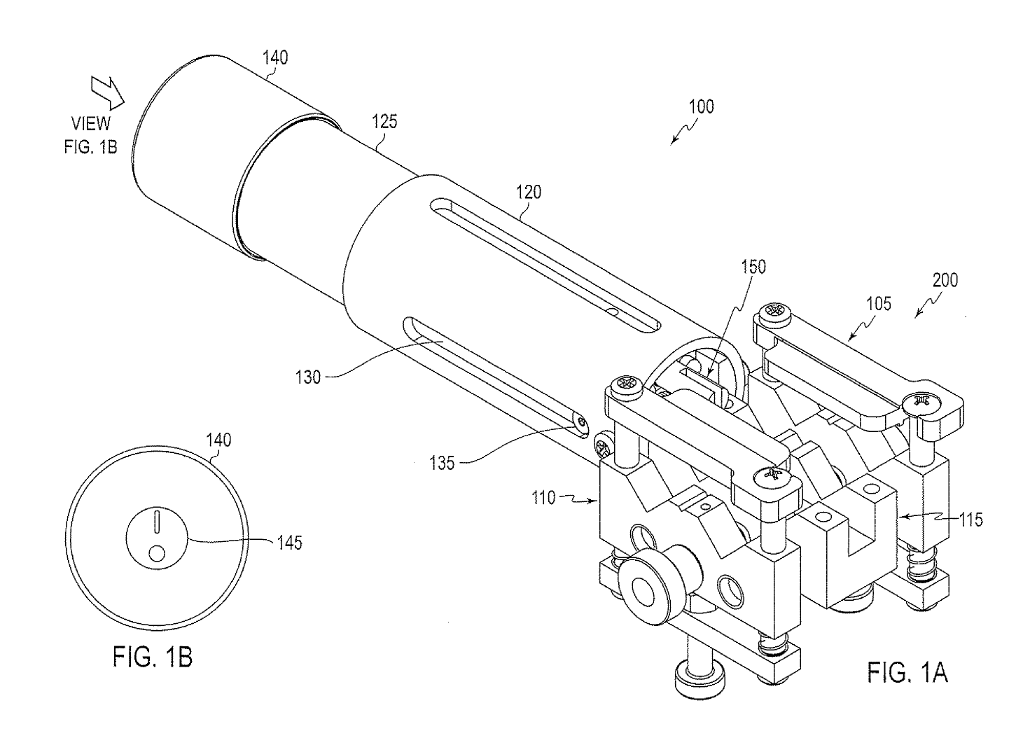

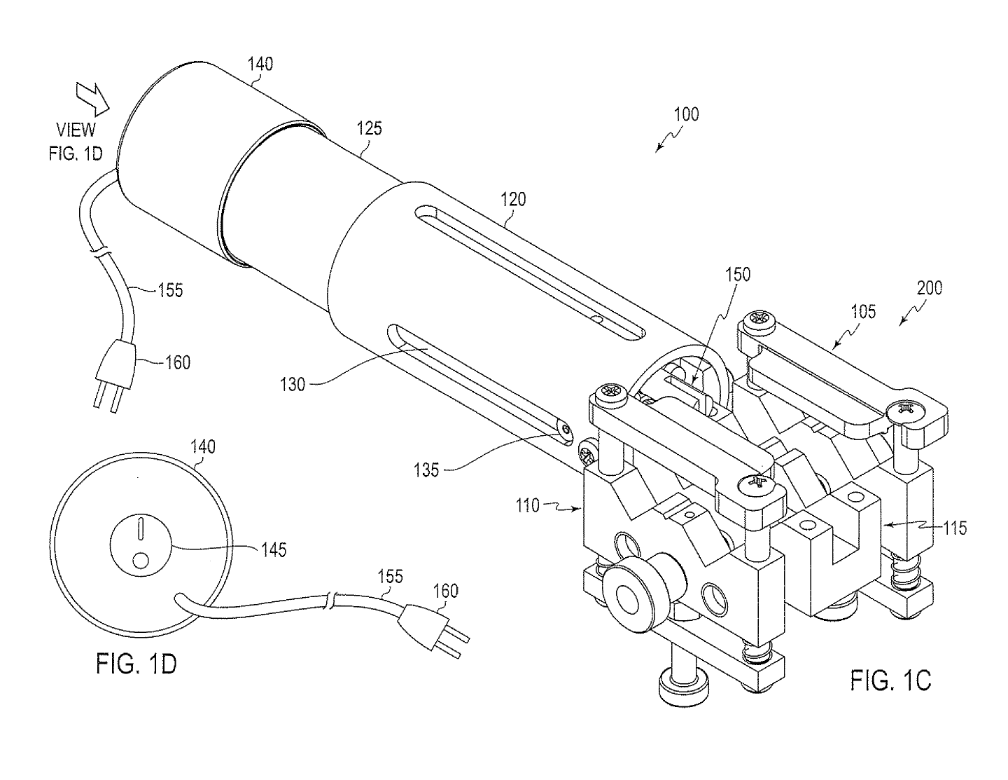

FIG. 1A illustrates an embodiment of a belt welder 100 according to the present application. As shown, the belt welder 100 includes a clamping mechanism 200 formed of at least one clamp, and preferably two clamps 105, 110 slidably connected to one another by way of an intervening clamp base 115. The clamps 105, 110 and clamp base 115 are axially connected to a sleeve 120 which is structured to receive a battery housing 125 inserted into the sleeve 120. The clamps 105, 110, clamp base 115, sleeve 120, and housing 125 are preferably made of metal.

The sleeve 120 includes a slot 130 that is shaped to receive a screw 135 that extends radially outward from the housing 125. The screw 135 can include a screw head with a diameter smaller than the width of the slot 130 to allow axial movement of the screw 135 within the slot 130. Additional slots 130 can be provided on the sleeve 120 and additional screws 135 can be received within the additional slots 130 to align the sleeve 120 with the housing 125. Each screw 135 can therefore impede axial movement of the housing 125 once the screw 135 contacts the extreme ends of the corresponding slot 130, and each screw 135 can impede rotational movement of the housing 125 with respect to sleeve 130 by contacting the upper and lower edges of the corresponding slot 130.

The housing 125 can be shaped like a tube to house cylindrical-shaped batteries. The housing 125 can also include threads at an end of the housing 125 opposite the clamps 105, 110 where a cap 140, preferably made of metal, can be attached. The cap 140 can be removable by way of these threads to allow a user access to the inside of the housing for, e.g., inserting and replacing batteries. As shown in FIG. 1B, the cap 140 can include a switch 145, e.g., acting between a metal battery contact (on the inside of the cap) and the external metal cap and housing from which the battery contact is otherwise insulated, for selectively distributing power from the batteries, e.g., by switching power on or off. In this way, the welder 100 can be operated using only battery power and without the need for a power cord.

As shown in FIG. 1C, the belt welder 100 can also or alternatively include a power cord 155 to allow a plug 160 to connect with a standard electrical outlet (e.g., an AC outlet). The power cord 155 can be attached to the belt welder 100 in any way that transmits power from the plug 160 to the welder 100. As shown, the power cord 155 can extend into the housing 125 through the cap 140. However, the power cord could also extend through another surface of the cap 140, or through the housing 125, sleeve 120, or any other part of the belt welder 100. The power cord 155 could also constitute an AC/DC adapter, removably plugged into the welder 100, for converting from AC power provided by an electrical outlet to DC power. In this way, the welder could alternatively be used with battery power or AC/DC adaptor power. Switch 145 can be adapted for use with any of these additions or alternative power sources.

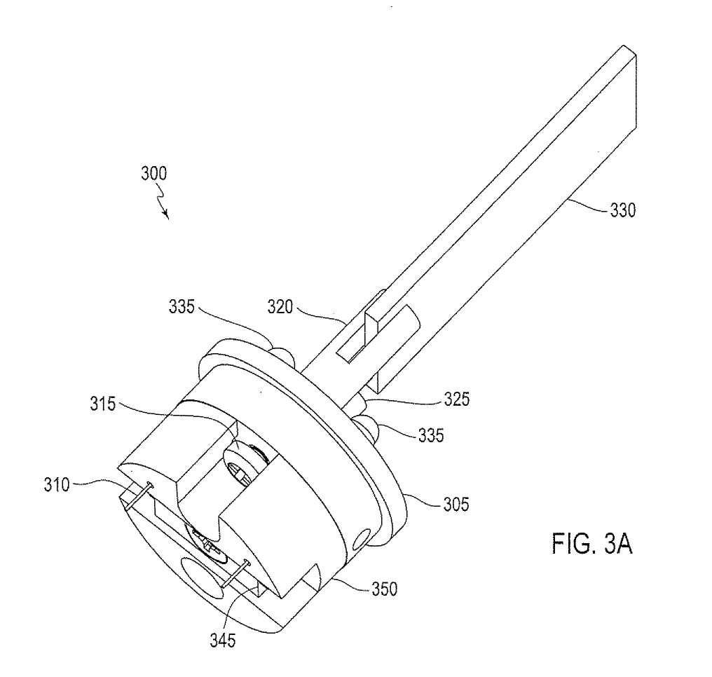

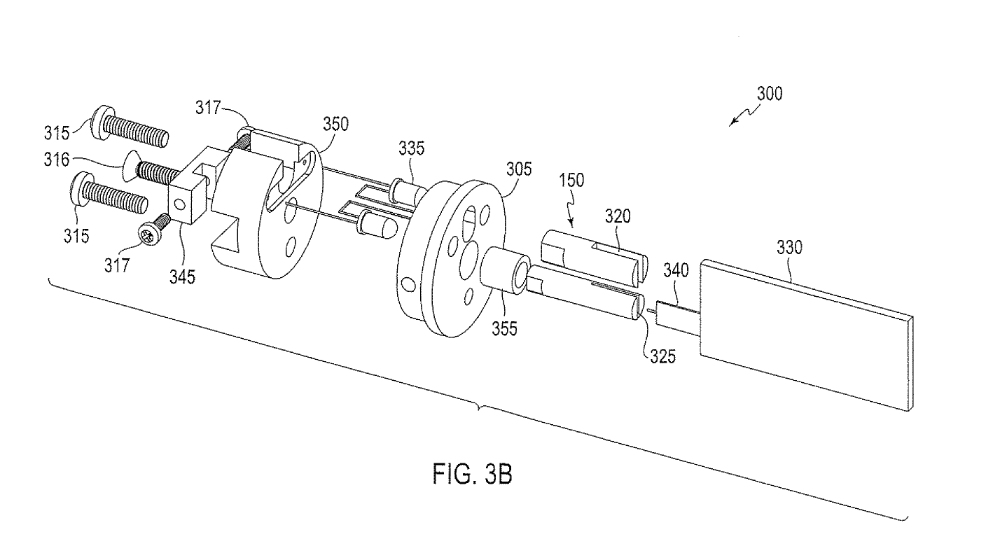

The housing 125 can further include a mount 150 for holding a heater element, such as a ni-chrome ribbon, as discussed below in more detail with reference to FIGS. 3A and 3B, where heater element 330 is shown. The heater element 330 can be partially, substantially, or entirely retracted within the sleeve 120 before and after the welding operation because of the movability of the housing 125 relative to the sleeve 120, as discussed above.

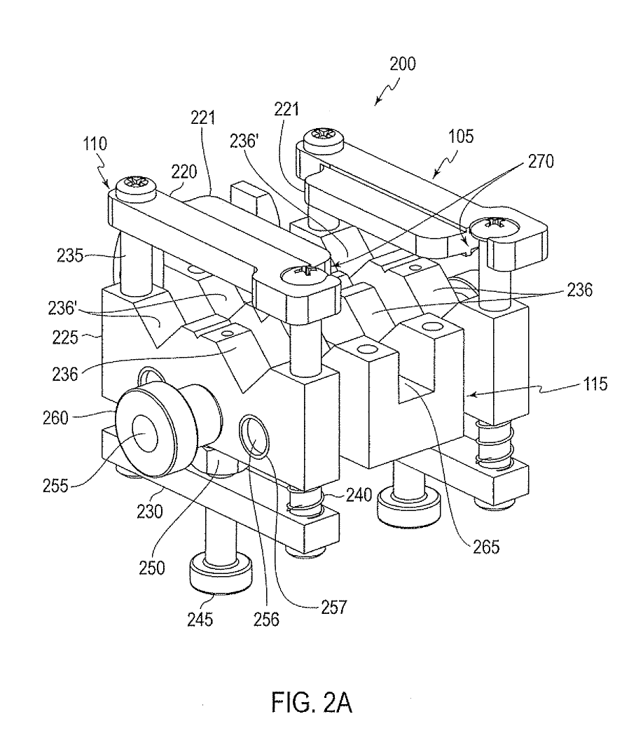

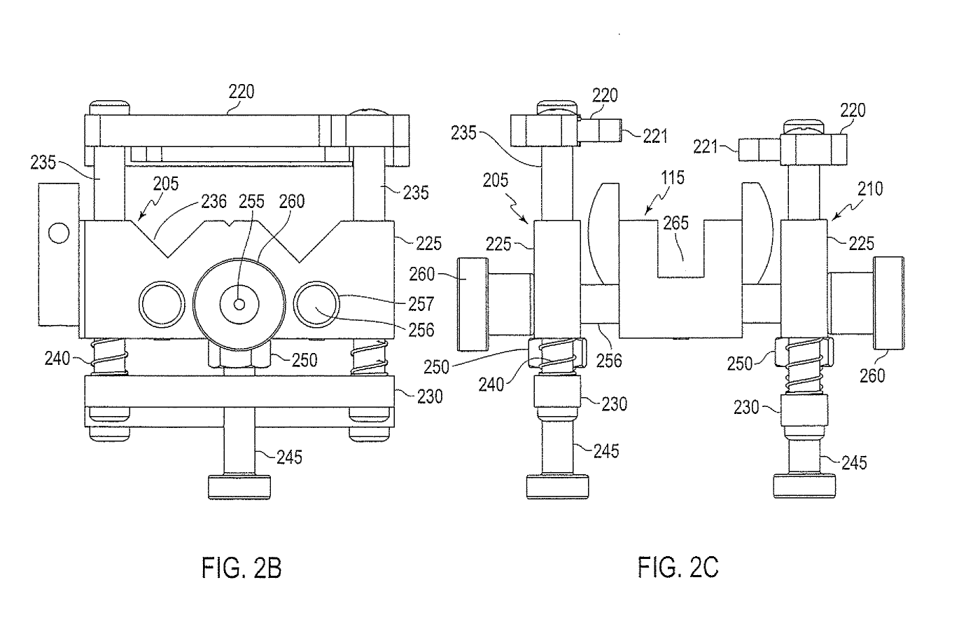

FIGS. 2A, 2B and 2C illustrate in greater detail the clamping mechanism 200 of the present embodiment. The clamping mechanism 200 includes at least one clamp, and preferably two clamps 105, 110 slidably connected to one another. Each clamp 105, 110 includes an upper body 220, a middle body 225 and a lower body 230 which are connected to one another by way of one or more bolts 235. More particularly, upper body 220 and lower body 230 may be fixed to opposite ends of bolts 235, and bolts 235 may be slidably received within holes in middle body 225, such that upper body 220 and lower body 230 may move upwardly or downwardly as a unit relative to middle body 225.

The middle bodies 225 of clamps 105, 110, and clamp base 115, can include grooves 236 to receive a circular, triangular, or other shaped workpiece and allow a more uniform application of pressure to the workpiece. The grooves 236 of the clamp base 115 can generally align with the grooves 236 of the middle bodies 225 to allow a workpiece to be inserted and aligned within the grooves 236. Other grooves 236′ of different size and/or shape can allow the user of the belt welder 100 to weld together a variety of sized and shaped workpieces rather than requiring a dedicated belt welder 100 for each size and shape of workpiece. Of course, grooves 236 and 236′ can also be of the same size and shape in order to handle multiple workpieces of the same size and shape. Alternatively, or in addition to the above, the middle bodies 225 and/or clamp base 115 may be flat and can allow for removable adapters (not shown) to provide various grooves or notches for a workpiece.

The clamp base 115 can further include a channel 265 in the middle of the clamp base 115 to allow for the insertion and removal of a heater element (shown in FIGS. 3A and 3B). The channel 265 can be any opening that allows the heater to be located between two ends of a workpiece. As shown, the channel 265 may be a rectangular opening that is axially aligned relative to the cylindrical housing 125 and sleeve 120. This structure allows the heater element to partially, substantially or entirely retract into the sleeve 120 and away from the user of the belt welder 100. However, any shaped channel 265 can be implemented without departing from the spirit and scope of the present application.

The upper body 220 may be formed of any shape so long as the upper body 220 can provide pressure against a workpiece when the workpiece is positioned between the middle body 225 and the upper body 220. For example, as shown, the upper body 220 can be generally flat so as to press against any workpiece, or can have grooves 236, 236′ corresponding to those of the middle body 225 to accommodate various sizes and shapes of workpieces, as discussed above. Also as shown, the upper body 220 can include an extended portion 221 so that upper body 220 is shaped wider than the middle body 225 and/or the lower body 230 so as to hold the workpiece ends down and to vertically align the workpiece ends relative to the heater element.

The extended portion 221 can extend over the clamp base 115 to retain a workpiece end when inserted onto groove 236 or 236′ of clamp base 115. As best shown in FIG. 2C, the extended portion 221 may be relieved above grooves 236, 236′ of clamp base 115 such that extended portion 221 is thinner than the portion of upper body 220 above middle body 225. This structure can reduce friction between clamp base 115 and the workpiece during operation and allow easier rotation of shaft 255. More particularly, the above structure allows for the free ends of a workpiece or workpieces to float between the clamp base 115 and the extended portion 221, even when the workpiece is tightly clamped between the upper body 220 and the middle body 225. The amount of floating can be determined by the amount of relief in extended portion 221 and the depths of the grooves 236, 236′ in clamp base 115.

The middle body 225 can include a threaded hole through which a threaded shaft 255 is inserted. The shaft 255 can include one or more knob(s) 260 that a user may turn in order to rotate the shaft 255 by hand. The shaft 255 can also be completely removed from the clamps 105, 110, and a replacement clamp or clamps, possibly with different sized or shaped grooves 236, 236′, may be inserted in place of one or both of the existing clamps 105, 110. In this way, the replacement clamp or clamps can allow for an even larger variety of workpiece sizes and/or shapes to be gripped by the clamping mechanism 200. The middle body 225 can be fixed to the clamp base 115 by way of the shaft 255, and the upper body 220 and lower body 230 can move relative to the middle body by way of the bolts 235 passing through the middle body 225.

For convenience, the shaft 255 can be left-hand threaded on the side of clamp 105 and right-hand threaded on the side of clamp 110, or vice-versa. Based on this structure, the shaft 255 can be rotated to simultaneously move both clamps 105, 110 toward or away from the clamp base 115 by turning one of the knobs 260. The portion of the shaft 255 that extends through the clamp base 115 can be a smooth, unthreaded rod whose axial position within clamp base 115 is maintained by way of a spring pin in clamp base 115 extending into a groove in shaft 255.

The clamping mechanism 200 can also include guide rods 256 that extend through the clamps 105, 110 and clamp base 115 to guide movement of the clamps 105, 110 relative to the clamp base 115. The guide rods 256 can be fixed to the clamp base 115 to provide a reference point for movement of the clamps 105, 110. As shown, the clamping mechanism 200 may include two guide rods 256 that are located equidistant from and on opposite sides of the shaft 255 to align the clamps 105, 110 and prevent rotational movement of the clamps 105, 110 around the shaft 255. The clamps 105, 110 can include bushings 257 to receive the guide rods 256 when inserted into the clamps 105, 110 to protect the structure of the clamps 105, 110 and facilitate smooth travel of clamps 105, 110 toward and away from clamp base 115.

The lower body 230 can include a threaded hole between the two bolts 235 to allow for an adjustment screw 245 to be inserted therein. The adjustment screw 245 can include a stopper 250 at its uppermost end to press against the middle body 225 when positioning the clamp 105 or 110 around a workpiece such as a thermoplastic belt. The adjustment screw 245 can also include a head at an opposite end from the stopper 250 that adjusts the adjustment screw 245 when turned by, for example, a user. The stopper 250 can be made of a material that cushions the contact between the adjustment screw 245 and the middle body 225, for example, nylon or synthetic rubber.

Springs 240 can be provided between the middle body 225 and lower body 230 to bias the upper body 220 toward or against the middle body 225, at least when a workpiece is inserted therebetween. For example, the springs 240 can be provided along and wrap around the bolts 235 on a portion of the bolts 235 located between the middle body 225 and the lower body 230. The springs 240 need not be fixed to either the middle body 225 or the lower body 230, but may be loosely disposed around the bolts 235. Alternatively, if the springs 240 are omitted, the force of gravity may be relied upon to hold a workpiece between upper body 220 and middle body 225 by the weight of upper body 220 and/or the lower body 230.

The bolts 235 can be fixed to both the upper body 220 and the lower body 230 (e.g., by threads and/or nuts and/or other known means), and may slidably extend through bores formed in the middle body 225. At least one of the bolts 235 may be inserted into a counterbore at the top of the upper body 220. The upper body 220 can include an opening 270 that allows the upper body 220 to be released from one of the bolts 235 and rotate about the other of the bolts 235 to allow for user access to the inside of the clamping mechanism 200. In this way, when the workpiece is an endless belt, the upper body 220 may be swung away to permit removal of the repaired endless belt from the belt welder 100.

FIGS. 3A and 3B illustrate one embodiment of a heater element assembly 300. As shown, the heater element assembly 300 can include an end cap 305, preferably made of metal, and an adjoining insulator or part 350, the end cap 305 being connected by threads, screws, or other known means to an end of housing 125 opposite from the end containing cap 140. An upper screw 315 may be used to hold a metal upper mount 320 against the end cap 305 to accurately hold a heater element 330, such as a ni-chrome heater element, while also providing an electrical connection to one terminal side of the battery power source. A second, lower screw 315 may be included to hold (or further hold) insulator 350 to end cap 305. As discussed more fully below, at least one warning light 335, such as a light emitting diode (LED) or other similar element for creating light, can also be provided within operator view on the end cap 305 and/or the insulator 350, with one of its leads 310 protruding through insulator 350 to the inside of housing 125 and its other lead being connected to end cap 305 or other metal outer structure. An insulator 355 may also be provided to electrically insulate a metal lower mount 325 from the end cap 305 and prevent short circuiting. Of course, if necessary, upper mount 320 could also, or alternatively, be insulated from end cap 305.

The end cap 305 and insulator 350 are shaped to enclose the housing 125 for batteries that may power the heater element 330 and/or the warning lights 335. As shown, the end cap 305 and insulator 350 are generally circular in shape, but they can be structured in any way that adequately contains a power source, such as batteries or a power cord 155, and facilitates its/their connection to electrically-powered components.

A metal contact 345 may be provided within the housing (at the opposite end from cap 140) to electrically connect the heater element 330 and/or the warning light(s) 335 with a positive or negative terminal of the batteries or power cord 155, metal structure of the welder serving as a connection for the other battery or power cord terminal. The contact 345 may be fixed to heater element 330 via the adjoining part 350 and the end cap 305 by way of one or more contact screw(s) 316, and lateral screws 317 may be used for connecting wire(s) 310 from the warning light(s) 335 to contact 345. In accordance with the above, power from the batteries or power cord can be distributed to the heater element 330 and/or the warning light(s) 335.

The insulators 350 and 355 may be made of any insulating material, including known polymers or ceramics. The insulators may be shaped to accommodate, support and fit with the various other components while also electrically insulating contact 345 and lower mount 325 from the end cap 305 and other outer metal structure. The batteries can be one or more standard batteries, such as D-cell, C-cell, AA-cell, AAA-cell, 6-volt, 9-volt, etc., or can be one or more specially designed batteries, such as one or more lithium-ion or nickel metal hydride (NiMH) batteries. Any of such batteries may be rechargeable, and may be in the form of removable, rechargeable battery packs. All of the components, including the electrical wires, contacts, connections, etc., can be reconfigured while still providing the indicated functions.

As discussed above, the warning light(s) 335 can be any light(s) that is/are located within view of the operator of the present embodiment. As shown, the embodiment of FIG. 3A includes two warning lights 335 located at an axial end of the adjoining part 350 and extending through end cap 305. In this way, the warning light(s) 335 can alert users that the switch 145 is on and that the heater element 330 is potentially hot. The warning light(s) 335 can be electrically coupled to the batteries or power cord and the switch 145 (shown in FIG. 1B) as described, and can emit light when current is provided to the heater element 330.

The upper mount 320 and the lower mount 325 can be structured in any shape so long as the heater element 330 is sufficiently supported and electricity is transmitted to the heater element 330. For example, the upper mount 320 and lower mount 325 may act as a negative terminal and a positive terminal (or vice-versa), respectively, to provide power to the heater element 330. Either or both of the upper mount 320 and/or the lower mount 325 can physically hold the heater element 330 in place. As shown, the upper mount 320 may be structured to contact both faces of the heater element 330 and the lower mount 325 may be simply inserted onto a terminal 340 of the heater element 330. However, any arrangement is suitable so long as power is provided to the heater element 330 and the heater element 330 is physically held in place during operation.

The heater element 330 itself can be shaped in any way that provides heat to a workpiece such as a thermoplastic belt. For example, as shown, the heater element 330 may be an electrical heating plate such that a workpiece can contact one or both faces of the heater element 330. The heater element 330 could also be a ribbon wrapped around a base plate, with electricity being provided to the ribbon, the base plate, or both. Still further, the heater element 330 could be a single movable electrical heating wire for quicker “startup” time as compared to a larger heater element 330.

The heater element 330 may be made of any material that emits heat when current is supplied to the heater element 330. As a preferred embodiment, the heater element 330 may be made of a ni-chrome alloy. However, any other metal, ceramic or other heat-emitting material may be used for the heater element 330 without departing from the spirit and scope of the present application.

An example operation of the present embodiment will now be briefly discussed with reference to FIGS. 1A-3B. Adjustment screws 245 should be sufficiently turned to move stoppers 250 away from the middle bodies 225 to thereby allow a workpiece to be placed within the grooves 236, 236′ formed in one or more of the clamps 105, 110 and/or clamp base 115. At this point, the workpiece is movably held in place by the bias of upper body 220 toward the workpiece and middle body 225 by springs 240. Once one end of a workpiece is properly positioned in a groove 236 or 236′ of one of the clamps 105 or 110 and on a corresponding proximate groove 236 or 236′ of the clamp base 115, the user can adjust the adjustment screw 245 for the given clamp so that the workpiece is tightly held between upper body 220 and middle body 225 within the grooves 236 or 236′. For example, the operator can turn the adjustment screw 245 until the stopper 250 contacts the middle body 225, and somewhat beyond, so as to exert force from the upper body 220 onto the end of the workpiece that is positioned on middle body 225 and clamp base 115. The other end of the workpiece can be inserted, positioned, and held in place by repeating the above process on the other clamp 105 or 110.

Once the two ends of the workpiece are positioned opposite to one another in the respective grooves 236, 236′ of the clamps 105, 110 and clamp base 115, the operator may then insert the heater element 330 into the channel 265 and position the heater element 330 for heating the two ends of the workpiece. The operator can now adjust the position of the two ends of the workpiece with the adjustment screws 245 and/or knobs 260 as may be necessary to ensure the alignment of the two ends of the workpiece with respect to one another. At this time, the workpiece ends may be engaged with the heater element 330 by turning the knob 260 and thus bringing the two ends of the workpiece into contact with opposite surfaces of the heater element 330, preferably so that the surface of each workpiece end is flush with a corresponding surface of the heater element 330. The operator can then activate the switch 145 so that power may be transmitted from the batteries or power cord 155, through the contact 345 and the wire(s) 310, thereby powering the heater element 330 and the warning light(s) 335, and causing the heater element 330 to heat up. The heater element 330 will heat up so as to melt the ends of the workpiece if such ends are held in contact with the heater element 330 for a sufficient amount of time (e.g., 60-120 seconds).

Alternatively, or in addition to the above, the switch 145 can be activated, and the heater element 330 powered and warmed up, prior to engaging the two ends of the workpiece against the heater element 330. During this warm-up time, the heater element 330 may be positioned within the channel 265 of the clamp base 115, or may be substantially or entirely retracted within the sleeve 120. This alternative approach may be somewhat faster, but may also be more prone to development of air bubbles in the workpiece.

Once it is determined that the heater element 330 has sufficiently melted the two ends of the workpiece, the two ends can then be brought out of contact with the heater element 330 by turning the knob 260 in a direction opposite to that turned when the two ends of the workpiece were brought into contact with the heater element 330. At this time, the heater element 330 may be partially, substantially, or entirely removed from the channel 265 by pulling on the housing 125 and thereby partially, substantially, or entirely retracting the heater element 330 into the sleeve 120. Once the heater element 330 is sufficiently removed from the channel 265, the two ends of the workpiece can then be engaged with one another by turning the knob 260 in the same direction as when the two ends of the workpiece were brought into contact with the heater element 330. The operator can then allow sufficient time for the workpiece to bond together after the two melted ends of the workpiece are brought into contact with one another (e.g., 30-60 seconds, or more or less, depending on the size of the belt and other factors).

Once the two ends of the workpiece weld together and solidify, the operator can remove the bonded workpiece from the belt welder 100 by again adjusting the adjustment screws 245 of both clamps 105, 110 to release the force on the workpiece. The upper bodies 220 may then rotate about their respective bolts 235 to allow the workpiece to be removed from the belt welder 100 if the workpiece, for example, is a thermoplastic endless belt. Any excess thermoplastic material can then be trimmed from the bonded workpiece using standard industry tools.

Although the above process was described with respect to thermoplastic workpieces, any workpiece material can be used so long as the heater element 330 is able to sufficiently melt the workpiece material. For example, any polymer or metal workpiece could be used, and welded together consistent with the spirit and scope of the present application so long as the heater element 330 receives enough power to heat and melt the polymer or metal workpiece sufficiently.

Also, the workpiece need not be a belt, but may be another configuration or shape that is welded together upon the application of heat. For example, the belt welder 100 of the present application could weld together two separate workpieces, two workpiece parts, or two ends of workpieces that are of different sizes and/or shapes. If the workpiece is an endless belt, the endless belt may be broken (and the workpiece parts may be the two ends of the broken endless belt) or the endless belt may be new (and the workpiece parts may be the two free ends of the new endless belt). Any workpiece number, configuration, size and/or shape can be used with the belt welder 100 consistent with the spirit and scope of the present application.

While the disclosed methods and systems have been described in conjunction with exemplary embodiments, these embodiments should be viewed as illustrative, not limiting. It should be understood that various modifications, substitutes, or the like are possible within the spirit and scope of the disclosed devices, methods and systems.

What is claimed is:

1. A handheld welder, comprising:
a sleeve;
a power source;
a housing slidably connected to the sleeve;
a heater element electrically connected to the power source; and
a clamping mechanism for clamping a workpiece, the clamping mechanism being coupled to the sleeve and including at least a first clamp having an upper body, a middle body and a lower body.

2. The handheld welder of claim 1, wherein the power source is one or more batteries located in at least one of the housing and an external location.

3. The handheld welder of claim 1, wherein the power source is a power cord adapted for connecting to an electrical outlet.

4. The handheld welder of claim 1, further comprising a spring, between the middle body and the lower body, which spring biases the upper body toward the middle body when a workpiece is inserted between the upper body and the middle body.

5. The handheld welder of claim 4, further comprising a second clamp having an upper body, a middle body and a lower body.

6. The handheld welder of claim 5, wherein at least one of each upper body and each middle body includes a groove to receive the workpiece.

7. The handheld welder of claim 5, further comprising:
a clamp base between the first and second clamps; and
a shaft, inserted into a threaded hole of the middle body of each of the first and second clamps for simultaneously moving the first and second clamps toward and away from each other.

8. The handheld welder of claim 7, wherein the upper body includes an extended portion that is configured to extend above the clamp base, the extended portion being thinner than a portion of the upper body above the middle body.

9. The handheld welder of claim 5, further comprising:
an adjustment screw threadably coupled to the lower body; and
a stopper provided on an end of the adjustment screw that faces the middle body.

10. The handheld welder of claim 5, the housing further comprising a cap coupled to an end of the housing distal from the heater element and including a switch for supplying power to the heater element.

11. The handheld welder of claim 7, the clamp base including a channel for receiving the heater element.

12. A handheld welder, comprising:
a sleeve;
a power source;
a housing slidably connected to the sleeve;
a heater element electrically connected to the power source; and
a clamping mechanism for clamping a workpiece, the clamping mechanism being coupled to the sleeve,
wherein the sleeve is structured to at least partially house the heater element within the sleeve when a portion of the housing is slidably withdrawn from the sleeve.

13. The handheld welder of claim 12, wherein the power source is one or more batteries located in at least one of the housing and an external location.

14. The handheld welder of claim 12, wherein the power source is a power cord adapted for connection to an electrical outlet.

15. The handheld welder of claim 12, wherein the clamping mechanism further comprises:
a first clamp having an upper body, a middle body and a lower body;
at least one bolt fixed to the upper body and the lower body and slidably provided within the middle body; and
a spring, between the middle body and the lower body, which spring biases the upper body toward the middle body when a workpiece is inserted between the upper body and the middle body.

16. The handheld welder of claim 12, wherein the sleeve is structured to at least substantially house the heater element within the sleeve when a portion of the housing is slidably withdrawn from the sleeve.

17. The handheld welder of claim 15, wherein the clamping mechanism further comprises:
a second clamp separated from the first clamp, the second clamp having an upper body, a middle body and a lower body;
a clamp base between the first and second clamps; and
a shaft, inserted into a threaded hole of the middle body of each of the first and second clamps, for simultaneously moving the first and second clamps toward and away from each other.

18. The handheld welder of claim 17, wherein the upper body includes an extended portion that is configured to extend above the clamp base, the extended portion being thinner than a portion of the upper body above the middle body.

19. The handheld welder of claim 15, further comprising:
an adjustment screw threadably coupled to the lower body; and
a stopper provided on an end of the adjustment screw that faces the middle body.

20. The handheld welder of claim 12, the housing further comprising a cap coupled to an end of the housing distal from the heater element and including a switch for supplying power to the heater element.

21. The handheld welder of claim 17, the clamp base including a channel for receiving the heater element.

22. A handheld welder, comprising:
a sleeve;
a power source;
a housing;
a clamping mechanism for clamping a workpiece, the clamping mechanism being coupled to the sleeve; and
a heater element connected to the housing and electrically connected to the power source, the heater element being movable relative to the clamping mechanism,
wherein one of the housing and the sleeve includes a screw and another of the housing and the sleeve includes a slot structured to receive the screw to allow axial movement while preventing rotational movement of the housing relative to the sleeve.

23. The handheld welder of claim 22, wherein the power source is one or more batteries located in at least one of the housing and an external location.

24. The handheld welder of claim 22, wherein the power source is a power cord adapted for connection to an electrical outlet.

25. The handheld welder of claim 22, wherein the screw extends radially outward from the housing, and the slot extends axially along the sleeve to receive the screw extending from the housing.

26. The handheld welder of claim 22, wherein the clamping mechanism further comprises:
a first clamp having an upper body, a middle body and a lower body;
at least one bolt fixed to the upper body and the lower body and slidably provided within the middle body; and
a spring, provided between the middle body and the lower body, which spring biases the upper body toward the middle body when a workpiece is inserted between the upper body and the middle body.

27. The handheld welder of claim 26, wherein at least one of the upper body and the middle body includes a groove to receive the workpiece.

28. The handheld welder of claim 26, wherein the clamping mechanism further comprises:
a second clamp separated from the first clamp, the second clamp having an upper body, a middle body and a lower body;
a clamp base between the first and second clamps; and
a shaft, inserted into a threaded hole of the middle body of each of the first and second clamps, for simultaneously moving the first and second clamps toward and away from each other.

29. The handheld welder of claim 28, wherein the upper body includes an extended portion that is configured to extend above the clamp base, the extended portion being thinner than a portion of the upper body above the middle body.

30. The handheld welder of claim 26, further comprising:
an adjustment screw threadably coupled to the lower body; and
a stopper provided on an end of the adjustment screw that faces the middle body.

31. The handheld welder of claim 22, the housing further comprising a cap coupled to an end of the housing distal from the heater element and including a switch for supplying power to the heater element.

32. The handheld welder of claim 28, the clamp base including a channel for receiving the heater element.

33. A method of welding parts of a workpiece using a handheld welder, the method comprising:
inserting the workpiece parts between upper clamp bodies and middle clamp bodies of a clamping mechanism;
turning adjustment screws between lower clamp bodies and the middle clamp bodies of the clamping mechanism to move the upper clamp bodies toward the middle clamp bodies and thereby provide compressive forces against the workpiece parts;
moving a heater element between the parts of the workpiece;
moving the parts of the workpiece against the heater element;
activating the heater element until the parts of the workpiece are at least partially melted;
removing the heater element from between the parts of the workpiece; and
moving the parts of the workpiece into engagement with one another to weld the parts together.

34. The method of claim 33, wherein, upon insertion of the workpiece parts into the clamping mechanism, springs are used to apply biasing forces from the upper clamp bodies toward the middle clamp bodies against the workpiece parts.

35. The method of claim 34, wherein the workpiece is an endless belt and the parts are two ends of the endless belt.

36. The method of claim 34, further comprising moving the parts of the workpiece away from the heater element after the parts of the workpiece are at least partially melted.

37. The method of claim 36, at least one of the moving the parts of the workpiece against the heater element, the moving the parts of the workpiece away from the heater element, and the moving the parts of the workpiece into engagement with one another further comprising turning a knob.

38. The method of claim 34, further comprising axially withdrawing a housing connected to the heater element from a sleeve of the handheld welder until the heater element is at least substantially housed within the sleeve.

39. The method of claim 38, wherein the withdrawing the housing includes sliding a screw on the housing within a slot on the sleeve, and wherein the slot is shaped to receive the screw and allow axial movement while preventing rotational movement of the housing relative to the sleeve.

40. A handheld welder, comprising:
a sleeve;
a power source;
a housing slidably connected to the sleeve, one of the housing and the sleeve including a screw and another of the housing and the sleeve including a slot structured to receive the screw to allow axial movement while preventing rotational movement of the housing relative to the sleeve;
a heater element electrically connected to the power source;
a clamping mechanism for clamping a workpiece, the clamping mechanism being coupled to the sleeve and having first and second clamps separated from one another, each of the first and second clamps having an upper body, a middle body and a lower body, the upper body including an extended portion that is configured to extend above the clamp base, the extended portion being thinner than a portion of the upper body above the middle body;
a spring, between the middle body and the lower body, which biases the upper body toward the middle body when a workpiece is inserted between the upper body and the middle body;
a clamp base between the first and second clamps; and
a shaft, inserted into a threaded hole of the middle body of each of the first and second clamps, for simultaneously moving the first and second clamps toward and away from each other,
wherein the sleeve is structured to substantially house the heater element within the sleeve when a portion of the housing is slidably withdrawn from the sleeve.

41. The handheld welder of claim 40, wherein the power source is one or more batteries located in at least one of the housing and an external location.

42. The handheld welder of claim 40, wherein the power source is a power cord adapted for connection to an electrical outlet.
